(19) United States
(12) Patent Application Publication
(10) Pub. No.: US 2008/0228512 A1
(43) Pub. Date: Sep. 18, 2008

(54) CROSS-JURISDICTIONAL TOWING ADMINISTRATION AND DATA MANAGEMENT SYSTEM

(76) Inventors: Michael Calkins, The Hills, TX (US); Lawrence Estes, Houston, TX (US); Keith Lancaster, Houston, TX (US); Kenneth Lancaster, Boulder, CO (US); Keith Raterink, Friendswood, TX (US)

Correspondence Address: BAKER BOTTS, LLP, 910 LOUISIANA, HOUSTON, TX, 77002-4995, US

(21) Appl. No.: 11/953,239

(22) Filed: Dec. 10, 2007

Related U.S. Application Data
(60) Provisional application No. 60/869,178, filed on Dec. 8, 2006.

(51) Int. Cl. G06Q 10/00

(52) U.S. Cl. 705/1

(57) ABSTRACT

Systems, computer programs, and methods for managing information corresponding to a plurality of vehicles are disclosed. The systems include a database for storing information corresponding to a plurality of vehicles, wherein at least one of the plurality of vehicles are non-consent tows and a plurality of user interfaces. Each user interface is configured to manage one or more pieces of information regarding one or more of the plurality of vehicles.

### CROSS-REFERENCE TO RELATED APPLICATION

This application claims priority to U.S. Provisional Patent Application Ser. No. 60/869,178, filed Dec. 8, 2006, which is hereby incorporated by reference.

### FIELD OF THE INVENTION

The present invention relates to methods and systems for the management and administration of non-consent vehicle towing operations conducted across multiple jurisdictions within a given geographic region.

### BACKGROUND OF THE INVENTION

Under a variety of circumstances, a vehicle may be towed without the owner's consent. The act of towing a vehicle without the owner's consent is commonly referred to as a “non-consent” tow. When a vehicle is towed without the owner's consent, it is typically taken to a storage facility (which may be referred to as a “storage lot”) until the owner makes arrangements to retrieve the vehicle. In general, non-consent tows fall into one of three general categories:
1. Explicitly authorized by a governmental agency.
2. Conducted on behalf of a private property owner.
3. Repossessions, conducted on behalf of the lien holder.

Governmental agencies, such as law enforcement agencies, authorize non-consent tows in a variety of circumstances. These circumstances include illegally parked, abandoned, seized, or disabled vehicles, vehicles involved in an accident, vehicles impounded for evidentiary or forensic purposes, or driver arrests. In a law enforcement authorized scenario, the on-scene officer typically fills out one or more of an electronic or paper “towslip” that documents relevant information, including, for example, a location of and reason for the tow, a description of the vehicle, the name of the wrecker company, and the name and location of the storage facility to which the vehicle will be taken, etc. In a private property or repossession scenario, the storage facility (or in some cases, the wrecker driver) is generally obligated to report similar information to an appropriate law enforcement agency within a specified time frame. Non-consent towing operations are generally regulated by city, county, and/or state ordinance. For some given locale, multiple governmental agencies may possess the authority to authorize non-consent tows. The agencies may include municipal police departments, county sheriffs, constables, municipal and volunteer fire departments, state police, highway patrol, state and federal marshals. In general, both law enforcement officers and wrecker drivers (or storage lots) are required to report non-consent tows to the agency with primary jurisdiction over the location from which a particular vehicle is towed. In some situations, jurisdictions may overlap. Cities, for example, reside within one (and sometimes more than one) county. Furthermore, in metropolitan areas, jurisdictional boundaries between cities, suburbs, and townships may not be obvious or well known, particularly to private citizens, wrecker drivers, or storage facilities. In addition, law enforcement agencies operating in overlapping or adjacent jurisdictions typically may not have the ability to share towing-related information. In combination, these factors give rise to a variety of issues:
Non-consent tows may be reported to the wrong law enforcement agency.
Private citizens attempting to locate a vehicle cannot readily determine the appropriate agency to contact.
An agency fielding a call from a citizen attempting to locate a missing vehicle cannot search the towing-related records of other agencies in the region to whom the tow may have been properly or improperly reported. In such a scenario, not only is the contacted agency incapable of adequately assisting the citizen, but in the absence of information as to the whereabouts of the vehicle, the citizen may file an erroneous stolen vehicle report.

A variety of so-called “point” solutions are available to enable law enforcement agencies to manage and administer towing information within the confines of a given jurisdiction. In existing systems, transactions that require access to towing-related records (e.g. “storage lot reports receipt of non-consent private property tow”, “citizen searches for vehicle”, etc.) may require the direct involvement and support of law enforcement agency personnel. These transactions may typically be conducted by telephone, and may result in inconvenience and delay for wrecker drivers, storage lot operators, and citizens, particularly during times of peak demand. This problem is exacerbated by the fact that citizens often initially contact the wrong law enforcement agency when attempting to locate a vehicle that was towed in an area with numerous overlapping or adjacent jurisdictions.

If the owner of a non-consent towed vehicle fails to retrieve the vehicle from a storage facility within a specified time, the vehicle is often deemed to be “abandoned,” and may be sold at auction. Proceeds from the sale are used to pay any outstanding towing and storage fees. Any remainder is typically remanded to the governmental agency that authorized the tow. Because available law enforcement agency point solutions generally do not provide an external interface for storage lots to report auction-related activity, law enforcement agencies must generally rely on paper-based “good faith” reporting for the management of auctions for unclaimed vehicles (and associated collection of fees). Further complexity is added by the fact that many storage lots are licensed to store non-consent tows authorized by multiple agencies within a given region, making it difficult for law enforcement agencies to audit abandoned vehicle auctions solely on the basis of physical storage lot inventory.

A variety of stakeholders in the business community also have a vested interest in towing-related information. Insurance companies, for example, must be able to locate policy-holder vehicles towed from an accident scene. Roadside assistance and concierge service providers may wish to offer subscribers assistance in locating towed vehicles. Lien-holders, such as lending institutions and automobile dealers, may wish to know when a vehicle in their inventory has been towed in order to expedite the asset recovery process. In the absence of a centralized repository of cross-jurisdictional towing information, these entities face the same challenges presented to individual citizens attempting to locate a towed vehicle.

### SUMMARY OF THE INVENTION

Accordingly, the present disclosure aggregates data pertaining to non-consent towing operations conducted across multiple jurisdictions in a given geographic region into a shared repository and exposes the ability to search, browse, and manage this data to a variety of constituents, including law enforcement agencies, wrecker drivers, storage lot operators, and private citizens.

The methods, systems, and computer software of the present disclosure may reduce the time and effort required by law enforcement officers to capture and record towing information for agency-authorized non-consent tows. The methods, systems, and computer software of the present disclosure may reduce the time and effort required by wrecker drivers and storage lot operators to capture and record towing information for private property and repossession non-consent tows. The methods, systems, and computer software of the present disclosure may enable wrecker drivers and storage lot operators to report the receipt of private property and repossession tows to local authorities without the need for the direct involvement or support of law enforcement agency personnel. The methods, systems, and computer software of the present disclosure may enable storage lots to report the release of a stored vehicle without the need for the direct involvement or support of law enforcement agency personnel. The methods, systems, and computer software of the present disclosure may enable law enforcement agencies and storage lots to better assist citizens attempting to locate a missing vehicle by providing direct access to data pertaining to all non-consent towing operations conducted within a given region without respect to jurisdiction. The methods, systems, and computer software of the present disclosure may enable private citizens to search for a vehicle without the need for the direct involvement or support of law enforcement personnel. The methods, systems, and computer software of the present disclosure may provide law enforcement agencies with accurate, reliable, up-to-date data on storage lot vehicle receipts and releases to facilitate the auction process for abandoned vehicles. The methods, systems, and computer software of the present disclosure may provide law enforcement officers with enhanced enforcement, evidentiary, and investigatory capabilities (such as the ability to place “holds” and “watches” on stored vehicles). The methods, systems, and computer software of the present disclosure may provide insurance providers with accurate, timely, up-to-date towed-vehicle data to expedite the location, adjustment, and disposition of policy-holder vehicles towed following an accident. The methods, systems, and computer software of the present disclosure may provide roadside assistance and concierge service providers with accurate, timely, up-to-date towed-vehicle data to facilitate the delivery of subscriber services pertaining to the location and recovery of towed vehicles. The methods, systems, and computer software of the present disclosure may provide lending institutions and automobile dealers with accurate, timely, up-to-date towed-vehicle data to expedite the location and recovery of vehicles in their lien portfolio that have been towed. Further objects and advantages will become apparent from a consideration of the drawings and ensuing description.

The present disclosure provides a centralized, shared repository for towing-related data, enabling the management and administration of non-consent towing operations conducted in overlapping and adjacent jurisdictions within a given geographic region, for the benefit of governmental agencies, wrecker drivers, vehicle storage lots, and private citizens.

The system is comprised of a data repository, a software program, a user interface, and an application program interface (to facilitate integration with existing computer systems). The system provides a variety of functional capabilities, including one or more of:
Initial entry, maintenance, and display of towslip data;
Acknowledgment of vehicle receipt at a storage facility;
Acknowledgment of vehicle release from a storage facility;
Vehicle holds and watches (placed by law enforcement officers);
Centralized vehicle search;
Reporting;
Proactive notification; and
Administration.

The system employs role-based security to ensure appropriate levels of access to data and functionality for various categories of users, and consequently requires users belonging to certain roles to log in using a unique username and password.

### BRIEF DESCRIPTION OF THE DRAWINGS

FIG. 1 is a flow chart of an example system according to one example embodiment.

FIG. 2 is a class diagram of the primary classes of one example embodiment.

FIG. 3 is a flow chart of the operational characteristics and features of one example embodiment.

FIG. 4 is a flow chart showing a workflow for agency authorized tows according to one example embodiment.

FIG. 5 is a flow chart showing a sequence diagram of the life-cycle of a private property tow according to one example embodiment.

FIG. 6 is a collection of screen shots illustrating a sample user-interface view depicting the storage lot inventory and search features of one example embodiment.

FIG. 7 is a screen shot showing a user-interface form supporting data-entry for reporting a private property non-consent tow according to one example embodiment.

FIG. 8 is a screen shot showing a sample user-interface form supporting data-entry for reporting an agency-authorized non-consent tow according to one example embodiment.

FIG. 9 is a screen shot showing a user-interface form supporting citizen search features according to one example embodiment.

FIG. 10 is screen shot of a sample user-interface form supporting global system search features according to one example embodiment.

FIG. 11 is a flow chart depicting a workflow for proactive notification according to one example embodiment.

### DETAILED DESCRIPTION OF THE INVENTION

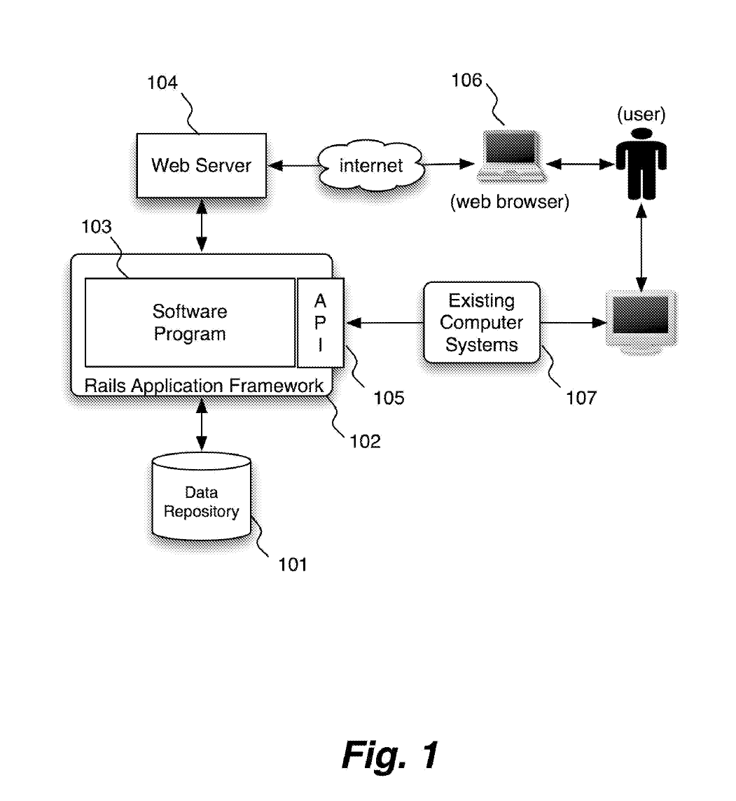

FIG. 1 provides an overview of a one example embodiment of the present invention, which is comprised of a data repository 101, an application framework 102, a software program 103, a web server 104, and an application program interface (API) 105. In the one example embodiment, the data repository is implemented as a relational database. In other example embodiment the data repository 101 is one or more of a flat data files, an XML repository, an object data base, or any other suitable data store. In the one example embodiment, the software program 103 is written in the programming language Ruby, utilizing the web application framework Rails 102, but could be implemented in any suitable contemporary computer programming language, utilizing any one of a number of available web application frameworks, and running on an appropriate application server for the language of choice. In one example embodiment, the web server is the Mongrel web server. In other example embodiments, the web server 101 is another server and may not necessarily be a web server. In one example embodiment, the API 105 is implemented as a set of web services. In other example embodiments, the API 105 is implemented utilizing any one of a number of contemporary methods, technologies, and protocols for exposing selected functional capabilities of a computer program to external systems through a platform-independent, language-independent, program-level interface over the Internet, a private network, or dedicated connection. In the one example embodiment, users interact with the system in one of two ways: through a browser-based web interface 106, or through existing external systems 107, integrated with the system of the present invention through the API 105. As one skilled in the art would appreciate, various technologies could be utilized to provide a user interface for a variety of suitable web-enabled devices, such as Personal Digital Assistants (PDAs) and cellular telephones.

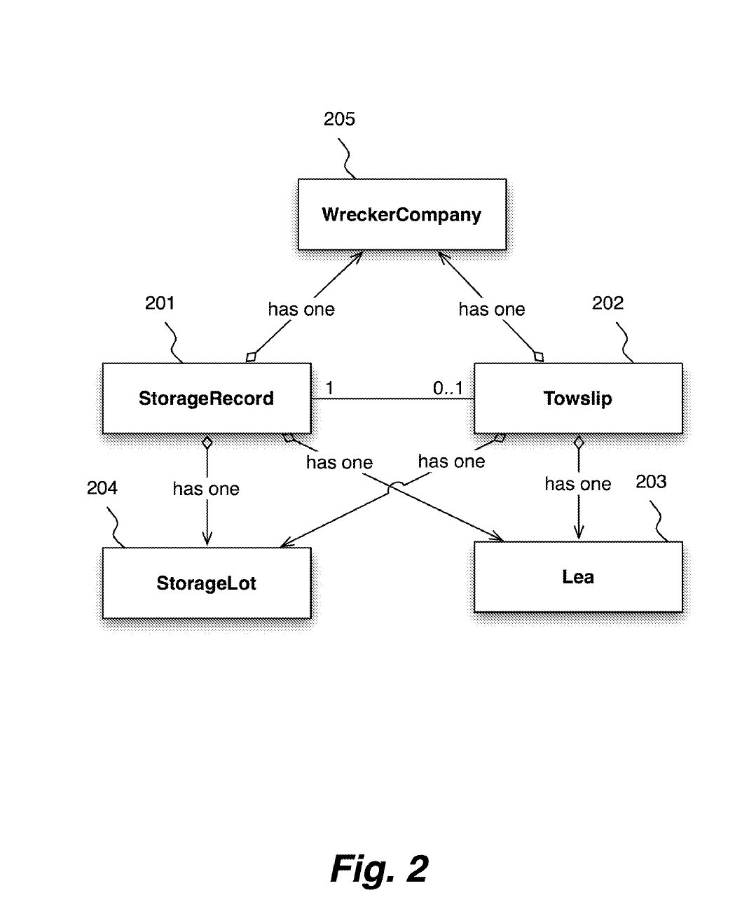

FIG. 2 is a Unified Method Language (UML) class diagram of the primary classes of one example embodiment. FIG. 2 presents the example entities of one example embodiment in the class model of the system. The primary entities include the storage record 201 and the towslip 202. One example storage record 201 is linked to an example towslip 202 for agency-authorized tows. In one example embodiments, storage records and towslips are each associated with one or more of a law enforcement agency 203, a storage lot 204, and a wrecker company 205. Other minor classes include, but are not limited to, vehicle colors and makes, users and their roles and rights, states and countries, and other system lookup data.

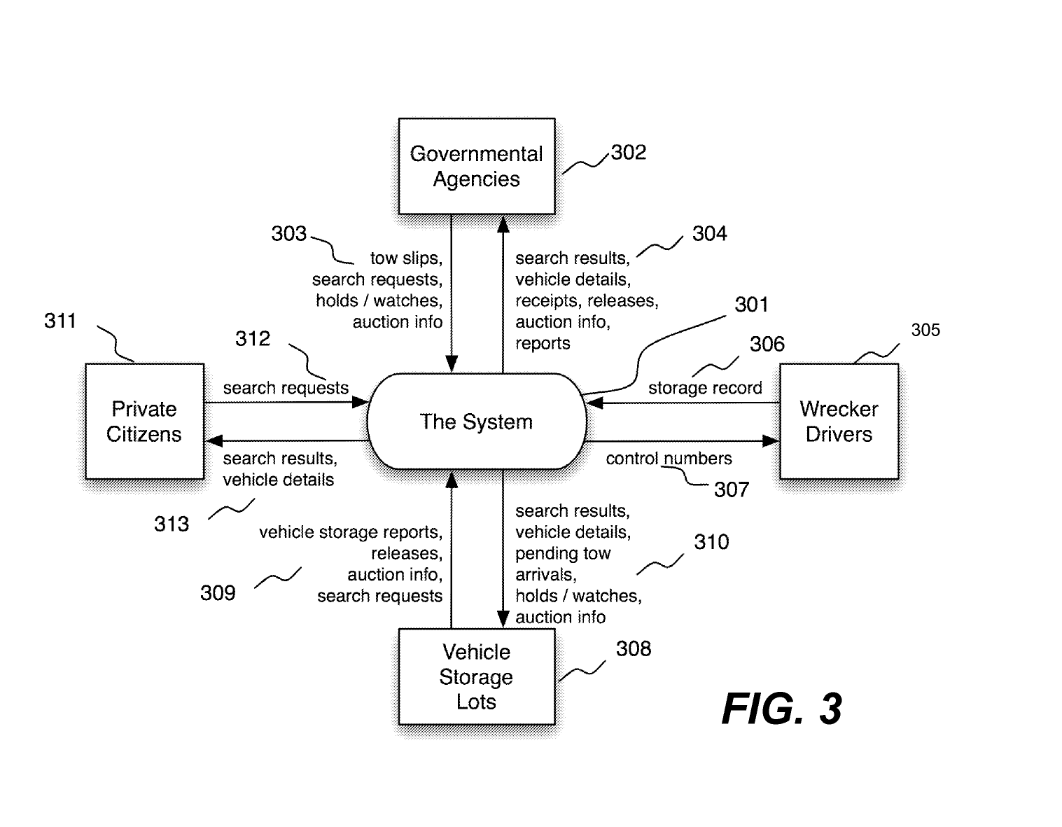

FIG. 3 provides an operational overview of a one example embodiment of the present invention. The system 301 is utilized by governmental agencies, such as law enforcement agencies, 302 to perform a variety of tasks 303, including, by way of example, but not limited to one or more of recording detailed information for agency-authorized tows, submitting vehicle search requests, placing holds and watches on vehicles, and entering auction-related data. The system provides governmental agencies with access to a variety of information 304, including, for example, but not limited to, one or more of vehicle search results, vehicle details, storage lot receipts and releases, auction-related data, and operational reports. In one example implementation, the system is utilized by Wrecker Drivers 305 to submit storage records 306 and to obtain control numbers 307. In an example implementation, the system is used by storage lots 308 to perform a variety of tasks 309, including, for example, but not limited to, one or more of recording detailed information for storage records, submitting vehicle search requests, entering vehicle release details, and entering auction-related data. The system provides storage lots with access to a variety of information 310, including, for example, but not limited to, one or more of vehicle search results, vehicle details, auction-related data, and operational reports. The system provides citizens 311 with the ability to perform search requests 312 and provides them with resulting information 313 including, for example, but not limited to, one or more of vehicle details, tow-event information, estimated cost and procedures for securing vehicle release, and storage lot location and contact information.

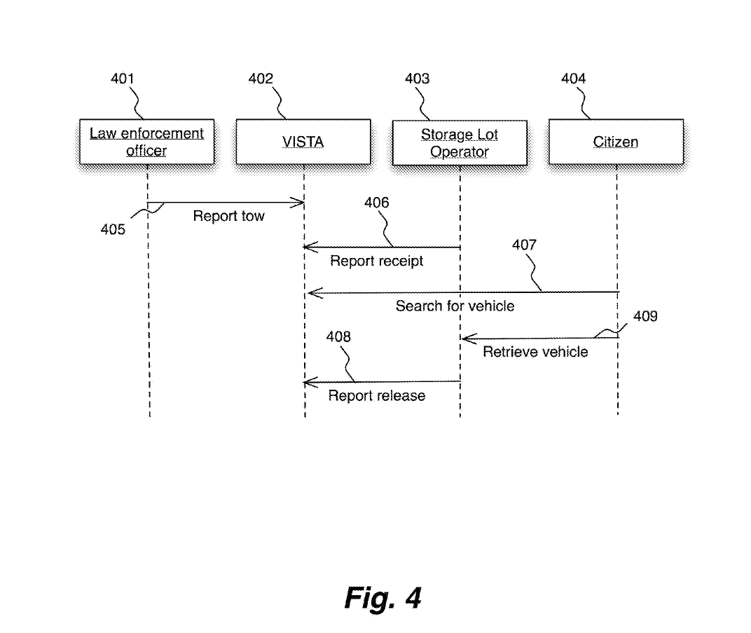

FIG. 4 is sequence diagram describing an example workflow associated with an agency authorized towed vehicle. The workflow begins when a law enforcement officer 401 initiates a non-consent-tow, calls for a wrecker, and reports a tow 405 to the system 402. In one example implementation, the initiation is performed from an accident or crime scene. When the wrecker arrives at the designated storage lot with the towed vehicle, the storage-lot operator 403 will report the receipt 406 of the vehicle to the system. In some example cases, the wrecker-driver rather than the storage-lot operator will report the receipt. The system now contains information about the non-consent tow event and the vehicle's current location. A citizen 404 may initiate a search 407 for their vehicle at any time in the sequence. If the vehicle is located in the system, the citizen is presented with information relevant to retrieving the vehicle from the storage lot including (but not limited to) the street address of the storage lot, phone number(s), and the anticipated storage and towing costs owed to the storage-lot operator to secure the vehicle's release 409. Upon releasing the vehicle, the storage-lot operator reports the release information 408 to the system. The result of this workflow is that the system has a real time inventory of vehicles stored at storage lots in the participating region, including timing and other details about the release. In the one example embodiment, communication with the system is supported in a variety of ways: using the available web-based UI from any commonly available web-enabled client; using a custom third-party application integrated with the API provided by the system; or interacting with a call-center or other system personnel. Other common communication techniques can be easily envisioned for the system.

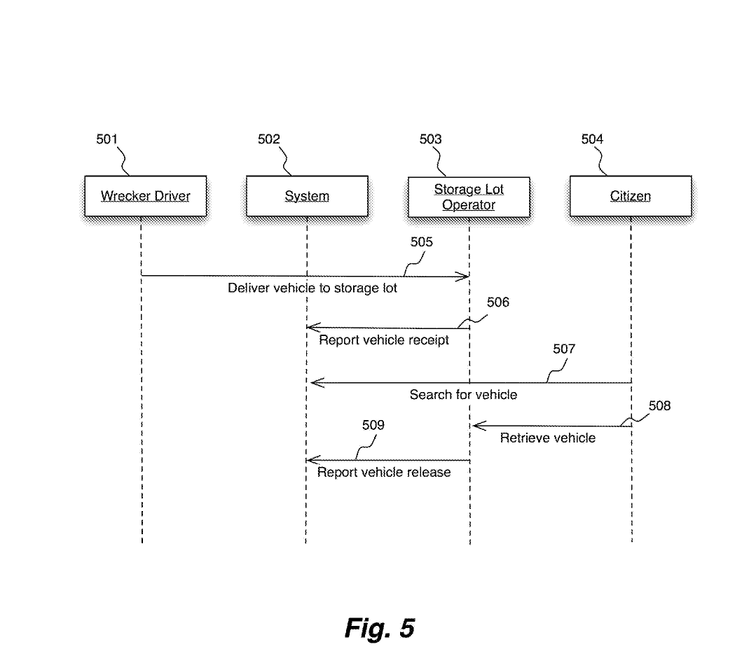

FIG. 5 provides a sequence diagram describing the workflow associated with a private-property non-consent tow. The workflow begins when the wrecker driver 501 delivers the vehicle 505 to the designated storage lot, the storage-lot operator 503 will report the receipt 506 of the vehicle to the system 502. In a few cases, the wrecker-driver 501 (rather than the storage-lot operator) will report the receipt. The system now contains complete, accurate, and up-to-date information about the non-consent tow event and the vehicle's whereabouts. A citizen 504 may initiate a search 507 for their vehicle at any time in the sequence. If the vehicle is located in the system, the citizen is presented with information relevant to retrieving the vehicle from the storage lot including (but not limited to) the street address of the storage lot, phone number(s), and the anticipated storage and towing costs owed to the storage-lot operator to secure the vehicle's release 508. Upon releasing the vehicle, the storage-lot operator reports the release information 509 to the system. The result of this workflow is that the system has a real time inventory of vehicles stored at storage lots in the participating region, including timing and other details about the release. In the one example embodiment, communication with the system is supported in a variety of ways: using the available web-based UI from any commonly available web-enabled client, using a custom third-party application integrated with the API provided by the system, or interacting with a call-center or other system personnel. Other common communication techniques can be easily envisioned for the system.

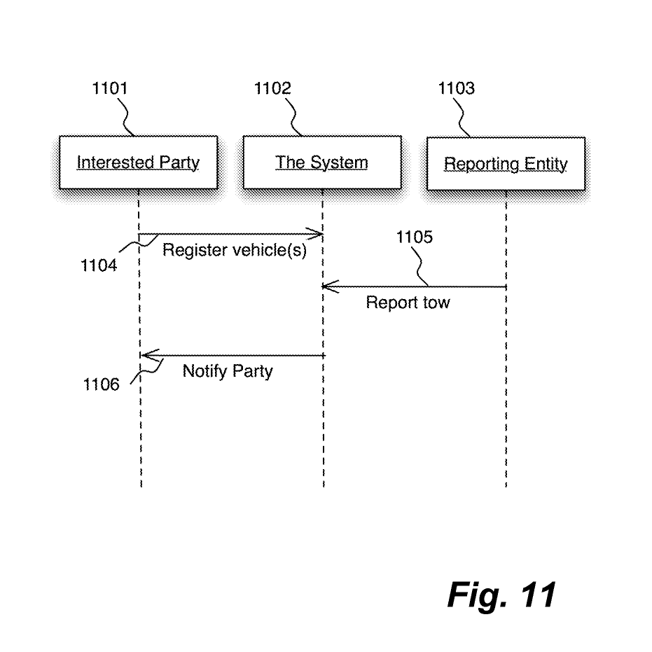

FIG. 11 provides a sequence diagram describing an example workflow associated with proactive notification of interested parties. Interested parties include, for example, but are not limited to one or more of vehicle lien-holders, fleet operators, insurance companies, concierge service providers, roadside assistance providers, individual vehicle owners, and law enforcement officers. An interested party 1101 declares interest in a particular vehicle or vehicles by registering 1104 a vehicle VIN or VINs with the system 1102. When a towed vehicle is reported to the system 1105, the system 1102 proactively notifies 1106 any party that previously registered the associated VIN as a vehicle of interest. In one example implementation, notification methods include, but are not limited to, email, fax, phone, pager, SMS messaging, and text messaging. As one skilled in the art would appreciate, various technologies and communication channels could be utilized to accomplish proactive notification. The content of a notification message includes, for example, but is not be limited to, one or more of a description of the towed vehicle, storage-lot address and phone number, law-enforcement agency contact information, vehicle-release requirements, and the date and time the vehicle was towed.

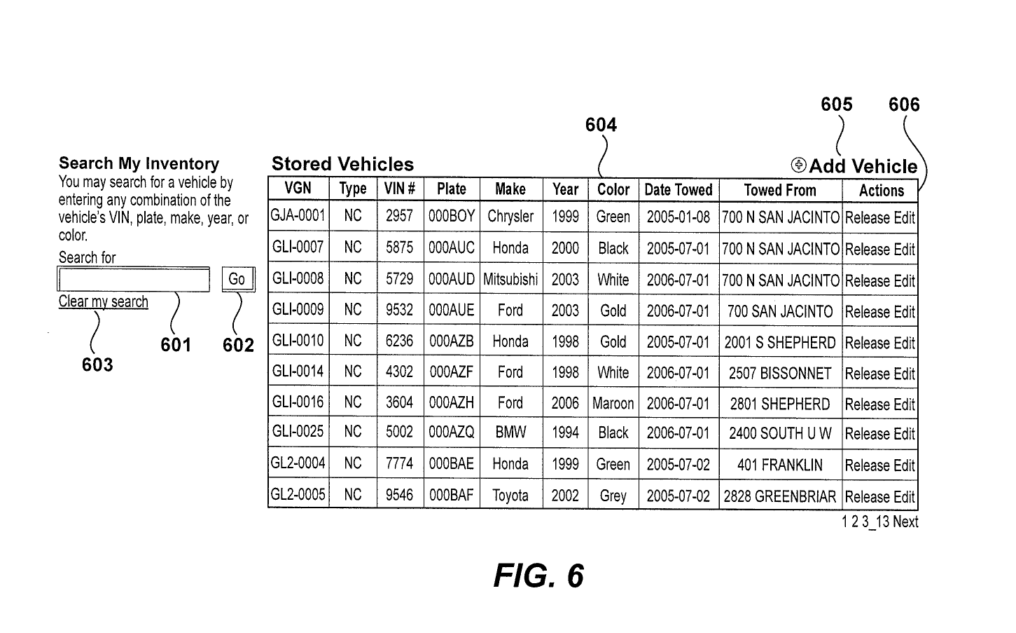

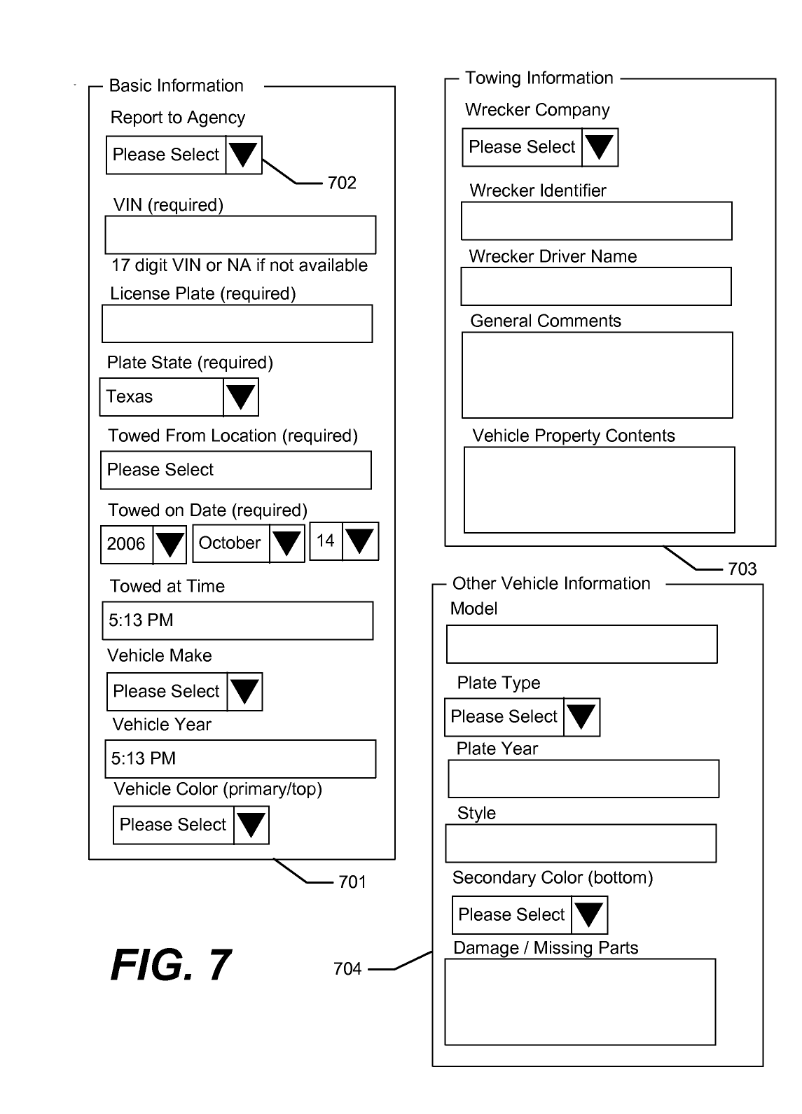

FIG. 6 provides a sample storage-lot inventory view. A storage-lot operator might use this view in a web-enabled client to view their current inventory and take appropriate actions to implement the workflow described in FIGS. 4 & 5. By default, the view 604 shows the current inventory, it lists all the vehicles currently stored at the storage lot. The storage lot identification for the system is encoded in the user's logon credentials. The list may be sorted by any of the data-columns by clicking on the label (column header) for that column. To report the receipt of a new vehicle into inventory, the operator selects the Add Vehicle button 605 and is then presented with the Storage Record form of FIG. 7. The operator may Report Release of the vehicle by selecting the Release link from the Action block 606. Editing a storage record's properties is accomplished by clicking the Edit link from the Action block. An operator may also search their inventory for vehicles by using the search functionality. A user searches by entering Search text into the search box 601 and then clicking the Go button 602. The system compares the search text against several relevant fields (one or more of license plate, vehicle make, vehicle color, etc.) of the storage record and then displays a list limited to those that match the search text appropriately. The search results include vehicles that may have been already released from inventory. The user may clear the search parameters by clicking the Clear My Search link 603. The sample view form is the one example embodiment of this functionality in a web-based UI. However, all of the system actions and results supported here could also be accomplished from any commonly available web-enabled client, using a custom third-party application integrated with the API provided by the system, or interacting with a call-center or other system personnel. Other common communication techniques can be easily envisioned for the system.

FIG. 7 provides a screen shot of an example data-entry form for reporting a private-property non-consent tow storage record to the system. In certain example implementations, a storage-lot operator uses this form in a web-enabled client. The Basic Information 701 provided includes information about the vehicle and the non-consent tow event. To support cross-jurisdictional requirements, the Basic Information section also includes the law-enforcement agency 702 to which this non-consent tow is being reported. For example, based on the originating location of the tow, a single storage lot may have to report non-consent private property tows to the city police department, the county sheriff, or the state police. The form also affords data-entry of optional additional towing information 703 and vehicle information 704. The information captured by this form is stored as a Storage Record in the system. The sample data-entry form is the one example embodiment of this functionality in a web-based UI. In other example implementations, reporting a non-consent private property tow to the system is accomplished from another web-enabled client, using a custom third-party application integrated with the API provided by the system or interacting with a call-center or other system personnel. In other example implementations, other communication techniques can be are used.

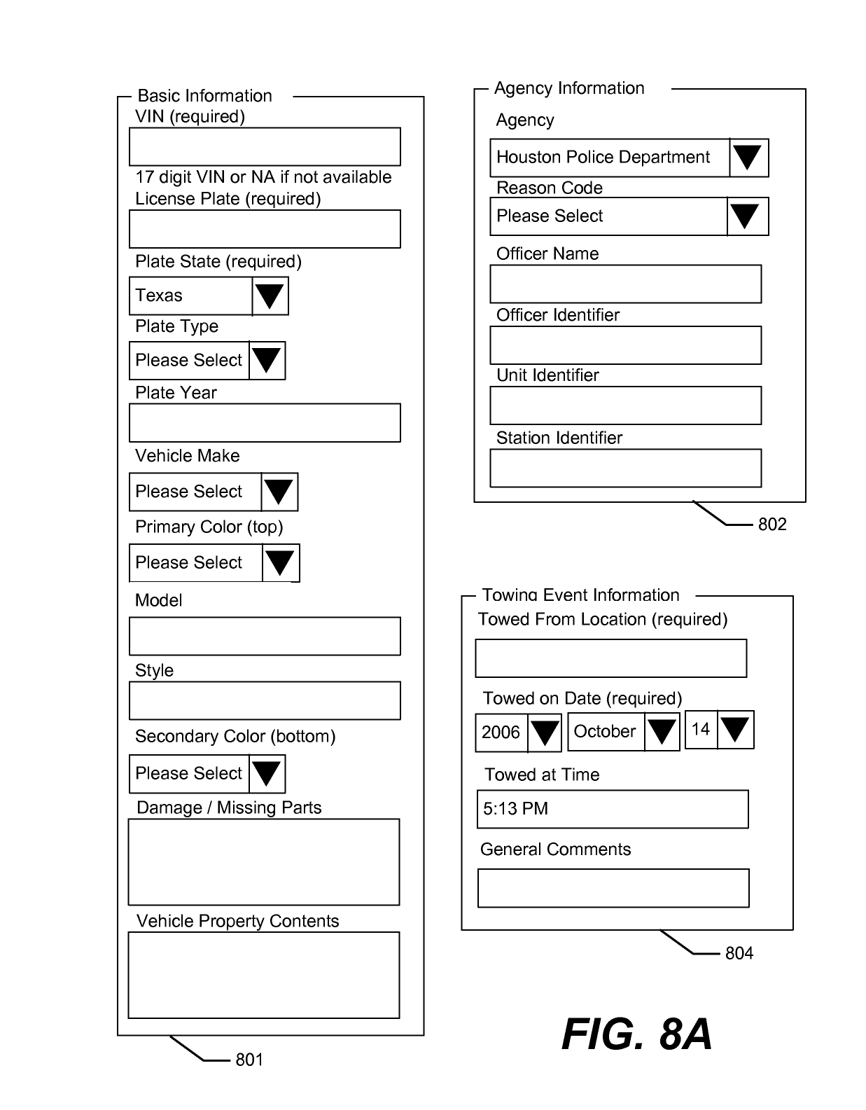

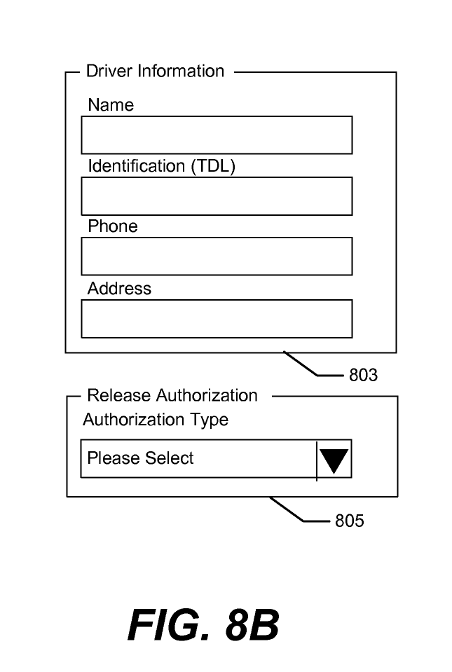

FIG. 8 provides a sample data-entry form for reporting a non-consent agency-authorized tow-record (towslip) to the system. A law enforcement officer might use this form in a web-enabled client. When an officer is on the scene of an accident (or other incident involving a vehicle disposition) the vehicle can be dispatched in two basic ways: it may be towed to an agency approved storage lot, or the vehicle may be released to an individual. When it is released to an individual, the individual may choose to have the vehicle towed to a specified destination, leave the vehicle parked on private property, or have the vehicle driven from the scene. The data-entry form shown here is capable of handling these variations and enforcing the corresponding data-entry requirements. The Vehicle Information section 801 provides a complete description of the vehicle. The Agency Information section 802 provides a description of the officer(s), agency vehicle(s), and incident identification(s) involved in the tow. The Driver Information section 803 captures information about the driver of the vehicle if available. The Towing Event Information 804 captures the date, time, and location of the tow if a tow occurs. The Release Authorization 805 specifies whether this vehicle was towed or released to an individual. The information captured by this form is stored as a Towslip in the system. The sample data-entry form is the one example embodiment of this functionality in a web-based UI. However, reporting a non-consent agency-authorized tow to the system could also be accomplished from any commonly available web-enabled client using a custom third-party application integrated with the API provided by the system, or interacting with a call-center or other system personnel. Other common communications techniques can be easily envisioned for the system.

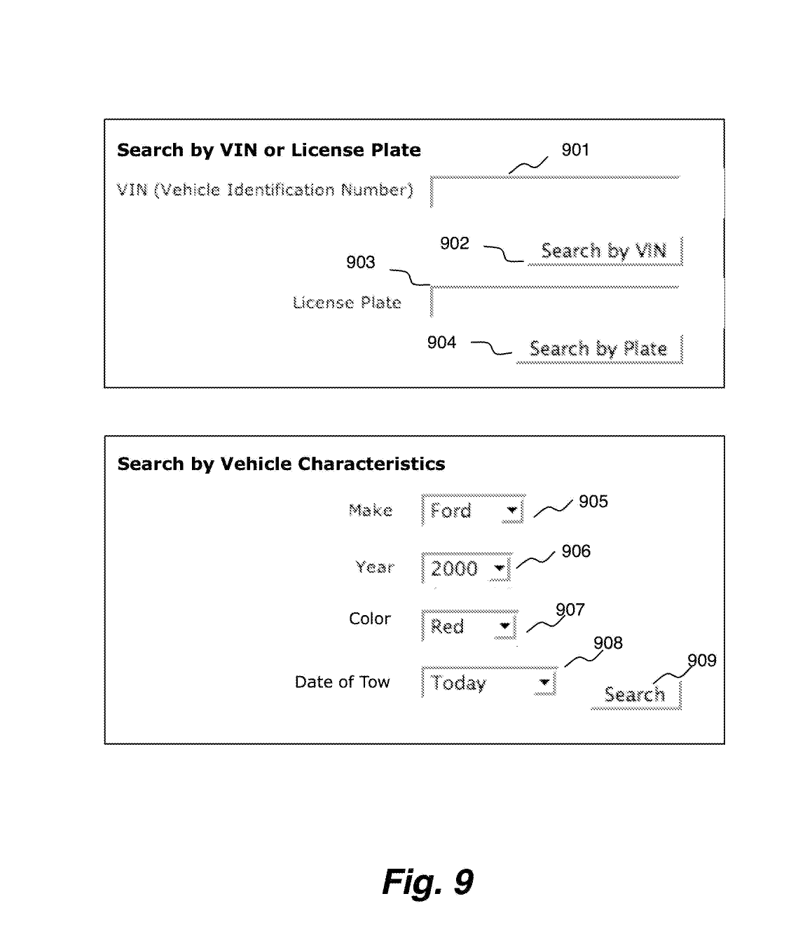

FIG. 9 provides a screen shot of an example citizen-search view. A citizen might use this view in a web-enabled client to locate their vehicle after a non-consent tow has occurred. The citizen can choose to search for his vehicle by providing the vehicle's Vehicle Identification Number (VIN) 901, providing it's license-plate number 903, or providing a descriptive set of vehicle characteristics 905-908. When using the VIN search 902, the system search algorithms will return all vehicles with exact VIN matches. Utilizing the Levenshtein distance algorithm for determining the “closeness” of two strings, the system also returns near matches where the VIN is up to two-characters different from the search request VIN. For example, if a user searches for CN123456789, near matches would include VINs CB123456789, CN223456789, and CN222456789 but would not include NC223456789. When using the License Plate search 904, the citizen may provide partial information and the system will return all vehicles having license plates that match the request. When using the Vehicle Characteristics search, the citizen must provide a vehicle Make 905, vehicle model Year 906, vehicle Color 907, and a Date of Tow 908. The system will return a list of all vehicles that match these characteristics. The citizen search features are designed to limit the opportunity for information “fishing” by submitting broad vague search requests and receiving large result sets in return. The sample search view is the one example embodiment of this functionality in a web-based UI. However, all of the system actions and results supported here could also be accomplished from any commonly available web-enabled client using a custom third-party application integrated with the API provided by the system or interacting with a call-center or other system personnel. Other common communication techniques can be easily envisioned for the system.

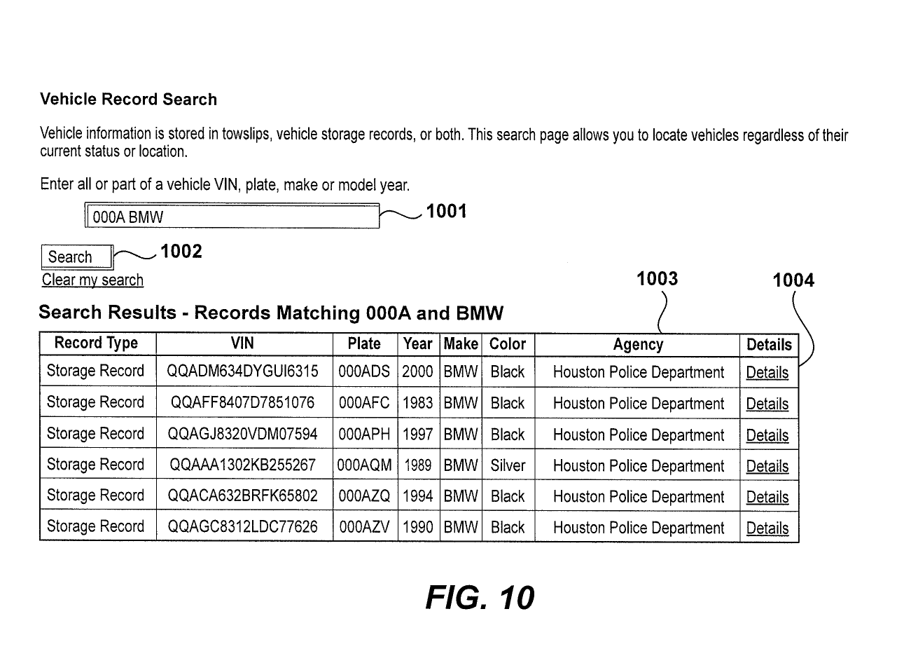

FIG. 10 provides a sample global system search view. In one example implementation, a law enforcement officer or a storage-lot operator uses this view in a web-enabled client to locate a vehicle in the system. The user can enter all or part of a vehicle VIN, license-plate, vehicle make, or vehicle model year 1001. The user may clear the search parameters by clicking the Clear My Search link 1005. Clicking Search 1002 returns all vehicles that match the provided characteristics regardless of the current disposition and location of the vehicle in the system. The search results returned will list all vehicles that matched the provided search characteristics 1003, with color-highlighting to signify areas where the displayed vehicle properties match the provided search characteristics. The users may select the details link 1004 from a vehicle row to see a form that displays all information from the Storage Record or Towslip. The sample search view is the one example embodiment of this functionality in a web-based UI. However, all of the system actions and results supported here could also be accomplished from any commonly available web-enabled client using a custom third-party application integrated with the API provided by the system, or interacting with a call-center or other system personnel. Other communication techniques may be used with the system.

In general, the system validates any VIN entered for a vehicle of year model 1981 or later. In one example implementation, a valid VIN must consist of exactly 17 characters, cannot contain certain designated characters (such the letter “Q”), and must include a check digit computed using an industry-standard algorithm. If a user-entered VIN is determined to be invalid, the system proposes valid alternatives based on likely data-entry errors. In one example implementation, the system attempts to formulate possible (valid) alternatives by performing a series of character substitutions as follows:
If the vehicle make/model/year encoded in the VIN does not match the make/model/year entered in the vehicle description, then the appropriate substitutions are made and the resulting VIN is revalidated.
If the VIN contains invalid characters, then a series of substitutions are made based on the physical appearance of each invalid character (e.g. zero is substituted for the letter “Q”), and the physical proximity to the invalid character on the QWERTY keyboard (e.g. the characters “A”, “W”, “1”, “2” may be substituted for the letter “Q”).

In general, when a user initiates a search for a vehicle based on color, the system attempts to match the requested color with a known vehicle color. In one example implementation, the system attempts to match the color based on the closeness of the requested color's spectrum (e.g., in terms of red, green, and blue (RGB) values) to “standard” vehicle colors. In another example implementation, the requested color is constrained to a master list of possible colors representing a superset of standard vehicle colors. Colors in the master list are explicitly mapped to colors in the standard list on the basis of closeness with respect to RGB values, making it possible to match a non-standard color (e.g., “wine”) with an industry-standard vehicle color (e.g., “maroon”).

The methods and systems above may be implemented in a computer system that includes one or more processors, memory, one or more input devices, and one or more output devices. As described above, the method and systems may be implemented in a client-server environment.

What is claimed is:

1. A system for managing information corresponding to a plurality of vehicles, including:
a database for storing information corresponding to a plurality of vehicles, wherein at least one of the plurality of vehicles are non-consent tows; and
a plurality of user interfaces, each user interface configured to manage one or more pieces of information regarding one or more of the plurality of vehicles.

2. The system of claim 1, where the plurality of user interfaces includes:
a vehicle owner user interface configured to search for a vehicle; and
where the database is configured to search for a vehicle based, at least in part, on information from the vehicle owner user interface.

3. The system of claim 2, where the vehicle owner interface is further configured to perform error checking of input information.

4. The system of claim 3, where when performing error checking the vehicle owner interface is further configured to determine one or more possible Vehicle Identification Numbers.

5. The system of claim 1, where the plurality of user interfaces includes:
a tow user interface configured to receive input information regarding a towed vehicle; and
where the database is configured to store the received input information regarding the towed vehicle.

6. The system of claim 1, where the plurality of user interfaces includes:
a storage lot operator interface configured to search for information regarding one or more vehicles at a storage lot; and
where the database is configured to perform a search based, at least in part, on the information from the storage lot operator interface.

7. The system of claim 1, where the plurality of user interfaces includes:
a storage lot operator interface configured to update information regarding one or more vehicles at a storage lot; and
where the database is configured to update information regarding one or more vehicles at the storage lot based, at least in part, on information from the storage lot operator interface.

8. A computer program, stored in a tangible medium for managing information corresponding to a plurality of vehicles, including executable instructions to cause at least one processor to:
store information corresponding to a plurality of vehicles, wherein at least one of the plurality of vehicles are non-consent tows; and
provide a plurality of user interfaces, each user interface configured to perform one or more operations on one or more pieces of information regarding one or more of the plurality of vehicles.

9. The computer program of claim 8, where the plurality of user interfaces includes:
provide a vehicle owner user interface configured to search for a vehicle; and
where the computer program further comprises executable instructions that case the at least one processor to search for a vehicle based, at least in part, on information from the vehicle owner user interface.

10. The computer program of claim 8, where the plurality of user interfaces includes:
a tow user interface configured to receive input information regarding a towed vehicle; and
where the database is configured to store the received input information regarding the towed vehicle.

11. The computer program of claim 8, where the plurality of user interfaces includes:
a storage lot operator interface configured to search for information regarding one or more vehicles at a storage lot; and
where the computer program further comprises executable instructions that case the at least one processor to search based, at least in part, on the information from the storage lot operator interface.

12. The computer program of claim 8, where the plurality of user interfaces includes:
a storage lot operator interface configured to update information regarding one or more vehicles at a storage lot; and
where the computer program further comprises executable instructions that case the at least one processor to update information regarding one or more vehicles at the storage lot based, at least in part, on information from the storage lot operator interface.

13. A method for managing information corresponding to a plurality of vehicles, comprising:
storing information corresponding to a plurality of vehicles, wherein at least one of the plurality of vehicles are non-consent tows; and
providing a plurality of user interfaces, each user interface configured to perform one or more operations on one or more pieces of information regarding one or more of the plurality of vehicles.

14. The method of claim 13, where the plurality of user interfaces includes:
provide a vehicle owner user interface configured to search for a vehicle; and
where the method further comprises searching for a vehicle based, at least in part, on information from the vehicle owner user interface.

15. The method of claim 13, where the plurality of user interfaces includes:
a tow user interface configured to receive input information regarding a towed vehicle; and
where the method further comprises storing the received input information regarding the towed vehicle.

16. The method of claim 13, where the plurality of user interfaces includes:
a storage lot operator interface configured to search for information regarding one or more vehicles at a storage lot; and
where the method further comprises searching based, at least in part, on the information from the storage lot operator interface.

17. The method of claim 13, where the plurality of user interfaces includes:
a storage lot operator interface configured to update information regarding one or more vehicles at a storage lot; and
where the method further comprises updating information regarding one or more vehicles at the storage lot based, at least in part, on information from the storage lot operator interface.
